(19) United States
(12) Patent Application Publication
(10) Pub. No.: US 2024/0252954 A1
(43) Pub. Date: Aug. 1, 2024

(54) FRACTIONATION OF CRUDE TALL OIL

(71) Applicant: Stora Enso OYJ, Helsinki (FI)

(72) Inventors: Jari Kavakka, Espoo (FI); Staffan Torssell, Bromma (SE)

(73) Assignee: Stora Enso OYJ, Helsinki (FI)

(21) Appl. No.: 18/564,200

(22) PCT Filed: Jun. 20, 2022
(86) PCT No.: PCT/IB2022/055688

§ 371 Date: Nov. 27, 2023

(30) Foreign Application Priority Data
Jun. 24, 2021 (SE) 2150817-1

(51) Int. Cl. B01D 15/36; B01J 41/05; C11B 3/06

(52) U.S. Cl. CPC B01D 15/363; B01J 41/05; C11B 3/06

(57) ABSTRACT

The present invention is directed to fractionation of crude tall oil, which originates from the Kraft process black liquor. In the method according to the present invention, strongly basic anion exchange resins are used to efficiently separate fractions from the crude tall oil.

### FIELD OF THE INVENTION

The present invention is directed to fractionation of crude tall oil, which originates from the Kraft process black liquor. In the method according to the present invention, strongly basic anion exchange resins are used to efficiently separate fractions from the crude tall oil.

### BACKGROUND

During production of Kraft pulp, black liquor is formed and removed from the produced pulp. The removed black liquor comprises soap which needs to be separated from the black liquor since the soap comprises valuable raw materials. The water from the black liquor is then evaporated and the black liquor soap is skimmed off and acidulated to make crude tall oil (CTO). Another reason to separate the soap from the black liquor is that the soap may cause problems during subsequent treatment steps of the black liquor.

The separated soap comprises extractives, water, lignin, inorganic compounds, fibers and some black liquor. The fatty and rosin acids of crude tall oil (CTO) are in the form of sodium salts in the soap. The amount of each component in the soap depends on the raw material, as well as seasonal variations thereof, used pulping process and on the process in which the soap is separated from the black liquor, i.e. the soap skimming process. The CTO is mainly composed of fatty acids (TOFA), rosin acids (TOR) and unsaponifiables.

Crude tall oil is a valuable raw material and it is important to recover as much of the crude tall oil from the soap as possible. Crude tall oil can be used as a raw material for various chemicals and other products, e.g. biodiesel or detergents.

It is possible to isolate CTO from the soap by addition of an acid to the soap at certain temperature. After mixing of the soap and the added acid, tall oil is formed and it then separates into three major phases due to density differences of the phases; a CTO phase, a lignin phase and a spent acid phase, also referred to as brine. The lignin and spent acid phase are rejects in the CTO production and they need to be separated well from the CTO phase during the recovery of the CTO.

The amount of acid needed to separate the optimal amount of CTO from the soap depends on the quality of the soap, e.g. the CTO content, the water content, the fiber amount, the lignin content and/or the black liquor content. Today it is common to measure the density of the soap, and the pH and density of the spent acid as a measure of the amount of acid and water that needs to be added to separate the optimal amount of the CTO from the soap. These measurements are done online, and the needed amount of acid and water is thereafter adjusted, i.e. feedback control.

Traditionally, CTO is fractionated using vacuum distillation to fractions like heads (low boiling compounds), fatty acids, rosin acids, and pitch (distillation residue). Also, due to similar boiling points of fatty and rosin acids, a middle fraction can be collected to prevent contamination of fatty and rosin acid fractions. During the distillation of CTO at high temperature alcohols are esterified with carboxylic acids resulting in lower yield of the free acid fractions and increase in the lower value pitch fraction. Furthermore, thermal decomposition of compounds may occur during high temperature distillation.

As described above, the CTO can be used for production of several different products. Alternatively, the CTO could be first separated into unsaponifiables and high acid number tall oil. The high acid number tall oil can be further separated into rosin acids and fatty acids. The unsaponifiables fraction comprises i.a. phytosterols.

Phytosterols have several uses, including the use as food additives and as precursors for steroids. Several methods have been reported for the isolation of sterols from tall oil soap, such as the extraction of neat soap with a variety of organic solvents.

Currently, phytosterols are commercially produced e.g. from tall oil pitch. Due to the ester formation during distillation, phytosterol esters must be hydrolyzed if production of free phytosterols is targeted. This requires additional process steps.

There is a need for easier and more efficient processes for producing phytosterols and preferably also high acid number tall oil from crude tall oil.

### SUMMARY OF THE INVENTION

It has surprisingly been found that the method according to the present invention can be used to more efficiently separate CTO into one neutral fraction and one neutral depleted fraction. The neutral fraction mainly comprises components generally described as unsaponifiables. The neutral depleted fraction mainly comprises components such as sodium salts of fatty acids and rosin acids.

Thus, the present invention is directed to a process for separating components from crude tall oil comprising the steps of
a) providing a mixture comprising crude tall oil and an alcohol selected from methanol, ethanol and/or iso-propanol,
b) bringing the mixture from step a) into contact with a strongly basic anion exchange resin and
c) recovering at least a first fraction and a second fraction, wherein each fraction comprises at least one component.

The present invention is also directed to the fractions recovered in step c) of the process of the present invention. In particular, the present invention is directed to a composition comprising sodium salts of fatty acids and rosin acids and to a composition comprising phytosterols. After additional process steps, a composition comprising high acid number tall oil can be obtained.

### DETAILED DESCRIPTION

During production of Kraft pulp, black liquor is formed and removed from the produced pulp. The removed black liquor comprises soap which needs to be separated from the black liquor since the soap comprises valuable raw materials. The water from the black liquor is then evaporated and the black liquor soap is skimmed off and acidulated to make crude tall oil. Crude tall oil can thus originate from pulping of softwood, hardwood or mixtures thereof.

The mixture used in step a) preferably comprises at least 1 wt-% of an alcohol selected from methanol, ethanol and/or iso-propanol, based on the total weight of the mixture. The alcohol is a solvent in which the tall oil is soluble and also enables the functioning of the strongly basic anion exchange resin. More preferably, the mixture used in step a) comprises at least 5 wt-% of an alcohol selected from methanol, ethanol and/or iso-propanol, such as at least 10 wt-% of an alcohol selected from methanol, ethanol and/or iso-propanol or at least 15 wt-% of an alcohol selected from methanol, ethanol and/or iso-propanol or at least 20 wt-% of an alcohol selected from methanol, ethanol and/or iso-propanol or at least 25 wt-% of an alcohol selected from methanol, ethanol and/or iso-propanol, based on the total weight of the mixture. Preferably, the mixture used in step a) comprises less than 75 wt-% of an alcohol selected from methanol, ethanol and/or iso-propanol, based on the total weight of the mixture. More preferably, the mixture used in step a) comprises less than 60 wt-% of an alcohol selected from methanol, ethanol and/or iso-propanol, such as less than 50 wt-% of an alcohol selected from methanol, ethanol and/or iso-propanol based on the total weight of the mixture. The mixture used in step a) may comprise other components than crude tall oil and an alcohol selected from methanol, ethanol and/or iso-propanol. However, the mixture used in step a) preferably comprises at least 40 wt-% crude tall oil, based on the total weight of the mixture. More preferably, the mixture comprises at least 50 wt-% crude tall oil, such as at least 60 wt-% crude tall oil or at least 70 wt-% crude tall oil at least 80 wt-% crude tall oil or at least 90 wt-% crude tall oil or at least 95 wt-% crude tall oil, based on the total weight of the mixture. Preferably, the alcohol used in the mixture used in step a) is methanol.

In one embodiment, the mixture used in step a) has been prepared by mixing an alcohol selected from methanol, ethanol and/or iso-propanol and crude tall oil. In one embodiment of the present invention, the mixture of an alcohol selected from methanol, ethanol and/or iso-propanol and crude tall oil has been brought into contact with a strong acid cation exchange resin before step b). A benefit of carrying out such strong acid cation exchange step before step b) is that alkali metal salts can be removed from the mixture and that the residual soap can be at least in part converted to neutral form before step b), which leads to higher yield and higher purity of the components in the first and second fraction.

The strongly basic anion exchange resin used in step b) is preferably an anion exchange resin with quaternary ammonium groups incorporated into the polymer frame.

In step b), the mixture of step a) is preferably brought into contact with a strongly basic anion exchange resin in a column. In step b), the mixture of step a) is added to the strongly basic anion exchange resin. When passing through the strongly basic anion exchange resin, the acidic components of the mixture adhere to the strongly basic anion exchange resin, whereas the neutral components of the mixture flow out of the resin and are recovered as the first fraction. The flow rate through the strongly basic anion exchange resin is preferably 0.5 to 4 bed volumes per hour. The amount of CTO loaded on to the resin is preferably 0.5-1 acid equivalent based on the strong basic anion exchange resin capacity. The temperature used in step b) is preferably in the range of from 10° C. to 80° C., more preferably in the range of from 20° C. to 60° C., such as from 30° C. to 60° C., such as from 40° C. to 60° C. or 30° C. to 50° C.

During step b), additional alcohol selected from methanol, ethanol and/or iso-propanol, optionally mixed with water, is optionally added to the column after the mixture of step a). Preferably, the additional alcohol added is methanol.

Subsequently, as part of step b), the acidic components that have adhered to the strongly basic anion exchange resin are released from the strongly basic anion exchange resin, preferably by addition of a mixture comprising sodium hydroxide and an alcohol selected from methanol, ethanol and/or iso-propanol. The concentration of sodium hydroxide in the mixture is preferably from 0.05 M to 6.0 M. The mixture of sodium hydroxide and alcohol selected from methanol, ethanol and/or iso-propanol optionally comprises 0 wt-% to 25 wt-% water, such as 0-10 wt-% or 1-10 wt-% water or 5-10 wt-% water. Preferably, the alcohol is methanol.

When the acidic components that have adhered to the strongly basic anion exchange resin are released from the strongly basic anion exchange resin, they are recovered as the second fraction.

After the second fraction has been recovered, the strongly basic anion exchange resin is preferably regenerated before repeating step b) using methods known in the art. Typically, the strongly basic anion exchange resin is regenerated at the same time that the acidic components are released from the strongly basic anion exchange resin. When the acidic components have been released from the strongly basic anion exchange resin, excess alkali can be removed from the strongly basic anion exchange resin by addition of pure alcohol selected from methanol, ethanol and/or iso-propanol. Preferably, the alcohol is methanol.

Thus, the process according to the present invention comprises the following steps:
providing a mixture comprising crude tall oil and alcohol selected from methanol, ethanol and/or iso-propanol;
optionally bringing the mixture comprising crude tall oil and an alcohol selected from methanol, ethanol and/or iso-propanol into contact with a strong acid cationic exchange resin;
bringing the mixture comprising crude tall oil and an alcohol selected from methanol, ethanol and/or iso-propanol into contact with a strongly basic anion exchange resin; and
   recovering at least a first fraction which comprises at least one component;
   releasing acidic components that have adhered to the strongly basic anion exchange resin from the strongly basic anion exchange resin, preferably by addition of a mixture comprising sodium hydroxide and an alcohol selected from methanol, ethanol and/or iso-propanol; and
   recovering a second fraction which comprises at least one component.

The first fraction recovered is a neutral fraction. The neutral fraction comprises components generally described as unsaponifiables. The neutral fraction comprises phytosterols.

From the first fraction (the neutral fraction), phytosterols are preferably separated from other neutral compounds. It has surprisingly been found that phytosterols may spontaneously crystallize in the first fraction. Advantageously, the phytosterols obtained are not esterified, which is typically the case with prior art methods. If such spontaneous crystallization cannot be achieved, the phytosterols may be separated from other neutral compounds by for example crystallization, such as evaporative crystallization, static crystallization or cooling crystallization, essentially using methods known in the art. The alcohol selected from methanol, ethanol and/or iso-propanol can be distilled off or alternatively be part of the precipitation/crystallization solvent system. The alcohol selected from methanol, ethanol and/or iso-propanol is preferably recycled in the process according to the present invention. Produced precipitate/crystals can be further purified by vacuum distillation or recrystallization or combination thereof, optionally followed by washing and drying.

One aspect of the present invention is a composition comprising phytosterols, wherein the composition comprises less than 0.5 wt-% tall oil and wherein the composition comprises less than 1 wt-% esterified phytosterols.

The second fraction recovered is the soap fraction, which can also be described as a neutral depleted fraction. The neutral depleted fraction comprises components such as sodium salts of fatty acids and rosin acids. It was surprisingly found that the acid salts may spontaneously crystallize/precipitate as a white precipitate/crystals in the second fraction. It was surprisingly found that the colour remains in the liquid phase. The crystallized/precipitated material can optionally be purified by subsequent recrystallization.

The second fraction can also be dried by evaporation of the alcohol selected from methanol, ethanol and/or iso-propanol using methods known in the art producing a dried mixture of fatty acid and rosin acid salts. The dried material can also be washed or re-slurried, for example washed with water or re-slurried in water, to remove excess sodium hydroxide from the dried material. Preferably, the washing is done with water, wherein the temperature of the water is preferably in the range of from 20° C. to 80° C., such as from 40° C. to 60° C. Preferably, the slurry has a temperature in the range of from 15° C. to 25° C. when the washing liquid is removed from the slurry. The sodium hydroxide removed can be recycled in the process.

The mixture of fatty acid and rosin acid salts can be further fractionated using for example precipitation/crystallization methods or be converted to high-quality tall oil using methods known in the art. The high-quality tall oil can be further fractionated to tall oil fatty acids and tall oil rosin acids with either a chromatographic system or by standard vacuum distillation. In one embodiment, the high acid number tall oil is first converted into a mixture of fatty acid methyl esters and rosin acids by esterification. The fatty acid methyl esters and rosin acids can subsequently be separated from each other using methods known in the art.

One aspect of the present invention is a composition comprising tall oil having an acid number of at least 175, said composition comprising less than 0.5 wt-% phytosterols, based on the total weight of the composition. The composition preferably has a Gardner Color Number of less than 14, more preferably less than 9, determined according to ASTM D1544-04.

The tall oil acid number can be determined using methods known in the art. One method of evaluating the quality of tall oil is to describe its acid number which is the amount of needed potassium hydroxide in milligrams to neutralize 1 g of CTO. As used herein, the term “high acid number tall oil” means tall oil having an acid number of at least 175 such as at least 180 or at least 185 or at least 188.

The term “phytosterol” is intended to mean a sterol derived from plants and encompasses all plant sterols and the saturated forms of phytosterols thereof (i.e., phytostanols). Plant sterols fall into one of three categories: 4-desmethylsterols (lacking methyl groups); 4-monomethylsterols (one methyl group); and 4,4-dimethylsterols (two methyl groups) and include, but are not limited to, sitosterol (e.g., [alpha] and [beta] sitosterol), campesterol, stigmasterol, taraxasterol, and brassicasterol. The term “phytostanol” is intended to mean a saturated phytosterol and encompasses, but is not limited to, sitostanol (e.g., [alpha] and [beta] sitostanol), campestanol, stigmastanol, clionastanol, and brassicastanol. Phytosterols isolated as described herein may be quantified by any means known in the art.

The phytosterol crystallization can be performed using methods known in the art, including cooling, concentration by removing some of the solvent by distillation, evaporation to dryness followed by introduction of a solvent or solvent mixture in which the phytosterols only dissolve at elevated temperature followed by cooling or through seeding with phytosterol crystals or by adding anti-solvent. The precipitation or crystallization may occur after a step of evaporating, such as distilling off, some of or all of said solvent. Alternatively, another solvent, such as an anti-solvent, may be added to facilitate precipitation or crystallization of the phytosterols, optionally in combination with seeding.

The process according to the present invention may be carried out as a batch process. However, by using more than one strongly basic anion exchange column, the process can be run continuously, by switching the flow of the mixture of step a) from a first strongly basic anion exchange column to a second strongly basic anion exchange column. In such continuous processing, the first fraction is thus recovered from the first strongly basic anion exchange column while the mixture of step a) flows through the first strongly basic anion exchange column. When the flow of the mixture of step a) is switched to flow through the second strongly basic anion exchange column, the second fraction can be recovered from the first strongly basic anion exchange column. This enables carrying out the process continuously.

Preferably, the crude tall oil is pre-processed before being subjected to the strongly basic anion exchange. The pre-processing preferably involves removal of fibers and any other components that may cause clogging of the strongly basic anion exchange column system.

### Example

### Materials

Small-scale preparative columns of IX (ion exchange) resin were constructed from Biotage ISOLUTE Single frit reservoirs using standard Luer fittings. Solutions were pumped using syringe pumps (Harvard Apparatus 11S).

### Preparation of Solutions

1.75 M Sodium hydroxide solution used for activation of ion exchange resins was prepared by dissolving solid sodium hydroxide (70 g/L) in 4/1 mixture of methanol and deionized water at room temperature.

0.67 M Sodium hydroxide in methanol was prepared by dissolving solid sodium hydroxide (26.8 g/L) in methanol at room temperature.

75 wt. % CTO solution in methanol was prepared by mixing Crude Tall Oil (217 g) with methanol (72 g). The resulting solution (289 g) was used for each separation cycle.

1.5 M Sodium hydroxide in methanol was prepared by dissolving sodium hydroxide (60 g) in methanol in a 1 L volumetric flask at room temperature. 50 wt. % CTO solution in methanol was prepared by dissolving Crude Tall Oil (100 g) in methanol (100 g). The resulting solution is deeply colored.

### Preparation of Strong Acidic Cation Exchange Resin (SAC)

Purolite PPC100H (22 mL) was loaded in a cartridge (Ø 22 mm, length 65 mm) between 10 μm polyethylene filter discs and swelled in methanol overnight. The methanol was drained and fresh methanol (50 mL) was pumped through the resin bed (up flow 45 mL/h). Sulfuric acid (70 mL, 4 vol % in water) is pumped through the resin bed (100 mL/h upflow) followed by demin water (150 mL, 45 mL/h). The SAC-resin was then rinsed with methanol (50 mL, 45 mL/h).

### Demineralization of 75 wt. % CTO in Methanol Using SAC-Resins

CTO-solution (200 mL, 182 g as 75 wt. % in MeOH) was pumped through the SAC-resin bed (up flow 20 mL/h) and the demineralized product was collected. The metal content of the sample before and after demineralization was analyzed using ICP. The data is an average of the three separate samples

| Sample | Ca (ppm) | K (ppm) | Na (ppm) |
|---|---|---|---|
| Before SAC | <0.5 | 2.1 | 25.6 |
| After SAC | <0.5 | <1.0 | <1.0 |

### Small-Scale Separation Experiments:

### Preparation of Strong Basic Anion Exchange-Resin (SBA)

Purolite A5000HPlus (12.4 g/20 mL) was loaded in a cartridge (Ø 22 mm, length 65 mm) between 10 μm polyethylene filter discs and swelled in methanol overnight. The SBA-resin was drained and sodium hydroxide (20 mL, 1.75 M in 4/1 mixture of methanol and water) was pumped through the resin bed (up flow 40 mL/h). The SBA-resin was then rinsed with methanol (110 mL) until conductivity <10 μS/cm.

### Isolation of Sterols Using 50 or 75 wt. % CTO in Methanol

CTO-solution (10 ml, 8.74 g as 50 wt. % in MeOH or 6.66 mL, 6.05 g as 75 wt. % in MeOH) was added to the SBA-resin (up flow 10-40 mL/h) followed by methanol (50 mL, 40 mL/h). Crystallization of white solids occurs in the early fractions (0.4-1.0 bed volumes) consisting mainly of sterols. Cooling to 4° C. of the early fractions gives a larger crop of crystalline material.

### Isolation of Fatty Acid and Rosin Acid Salts and Regeneration of IX-Resins

A solution of sodium hydroxide in methanol (1.5 M, 40 mL) was added to the SBA-resin followed by methanol (120 mL, flow 40 mL/h) until conductivity <10 μS/cm. Precipitation of soap as white solids occurs in the early fractions (0.4-1.4 bed volumes) at ambient temperature. Cooling to 4° C. causes heavy precipitation of white material.

### Large-Scale Separation Experiments:

### Preparation of Strong Basic Anion Exchange-Resin (SBA)

Purolite A5000HPlus resin (640 g) was loaded into a jacketed stainless-steel column (ID 50 mm, length 500 mm, volume 1 L) between 10 μm polyethylene filter discs and the column was closed in both ends with end caps having an inlet and an outlet connected with Teflon tubing for injection and collection. Methanol is added from the top and the resin was allowed to swell overnight. The methanol was drained and sodium hydroxide (2 L, 1.75 M in 4/1 mixture of methanol and water) was pumped through the resin bed (downflow 2 L/h). The IX-resin was then rinsed with methanol (3 L) until conductivity <10 μS/cm.

### Isolation of Sterols Using 75 wt. % CTO in Methanol

The resin column was heated to 50° C. using a heated water circulator bath through the heating jacket of the column and the temperature was maintained throughout the separation process.

The CTO-solution (289 g as 75 wt. % in MeOH) was added to the IX-resin (1.5 BV/h). The neutral compounds were eluted with methanol (850-1000 mL, 1.5 BV/h) using a HPLC-pump and collected as the first fraction. Crystallization of pale-yellow solids occurs and consisting mainly of sterols. Cooling to 4° C. of gives a larger crop of crystalline material. The solid material was filtered off and washed with cold methanol (50 mL) and dried under reduced pressure to give crude sterols (7.9 g, 3.6 wt % of in-going CTO) as a pale yellow solid.

The combined methanolic filtrate was evaporated under reduced pressure to give an orange oil (19.8 g, 9.1 wt % of in-going CTO). The evaporated methanol was collected for optional solvent recovery.

### Isolation of Fatty Acids and Rosin Acids and Regeneration of IX-Resin

The acidic compounds were eluted from the IX-resin column using a solution of sodium hydroxide in methanol (0.67 M, 1.5 L, 1.5 BV/h) using a HPLC-pump and collected as the second fraction. Precipitation of soap as off-white solids occurred at ambient temperature. Cooling to 4° C. causes heavy precipitation of off-white material. The off-white precipitate can optionally be isolated via filtration to generate a Na-soap fraction enriched in Na-fatty acid soap.

The combined collected soap fraction (the second fraction) was evaporated to dryness under reduced pressure and the evaporated methanol was collected for optional solvent recovery. The dried brownish Na-soap (295 g) contains excess NaOH from the eluent and has a fatty acid to rosin acid ratio of 54:46. The isolated Na-soap can directly be converted into neutral-depleted high acid number tall oil using procedures know in literature using conc. H₂SO₄ to give a brown oil (184.1 g, 84.8 wt % of in-going CTO) having an acid number of 189.

Total isolated products, 27.7 g neutral products and 184.1 neutral depleted high acid number tall oil, corresponds to 97.6 wt % of in-going CTO (217 g).

### Conditioning of the IX-Resin Column

After the elution and regeneration of the resin column using sodium hydroxide in methanol, the column was rinsed with methanol (2 L, 1.5 BV/h) using the HPLC-pump. The methanol was collected for optional solvent recovery and the IX-resin column is now conditioned for a new separation cycle.

### Soap Washing and NaOH Recovery

To remove and recover the excess NaOH from the isolated Na-soaps, 25 g of dried soap was re-slurried in 5 vol of water at 50° C. for 15 min and then cooled to ambient temperature. The solids were isolated in a pressure filter using pressurized air (1 barg) and the filtrate was collected. The washed Na-soaps had a moisture content of 15-30 wt %. The filtrate was titrated and the free NaOH was determined to be 0.183 g/g dried soap used.

### Isolation of Neutral-Depleted High Acid Number Tall Oil

The washed and filtered Na-soap residue was resuspended in water (200 mL). The pH of the solution was adjusted to 2 by addition of conc. H₂SO₄ at ambient temperature. The aqueous mixture was extracted three times with MTBE (100 mL) and the combined organic layers were evaporated under reduced pressure to give neutral depleted high acid number tall oil (16.2 g) as a brown oil having an acid content of 3.37 mol/kg or an acid number of 189.

### Analytical Methods

Identity and purity of individual components or classes of components were determined using GC/FID after silylation with BSTFA N,O-bis(trimethylsilyl)trifluoroacetamide) in pyridine or with ³¹P-NMR after derivatization with 2-chloro-4,4,5,5-tetramethyl-1,3,2-dioxaphospholane in deuterated chloroform/pyridine according to known procedures.

In view of the above detailed description of the present invention, other modifications and variations will become apparent to those skilled in the art. However, it should be apparent that such other modifications and variations may be affected without departing from the spirit and scope of the invention.

1. A process for separating components from crude tall oil comprising the steps of
a) providing a mixture comprising crude tall oil and an alcohol selected from a group consisting of: methanol, ethanol, iso-propanol, and mixtures thereof,
b) bringing the mixture from step a) into contact with a strongly basic anion exchange resin, and
c) recovering at least a first fraction and a second fraction, wherein each fraction comprises at least one component.

2. The process according to claim 1, wherein one of the first or second fractions comprises unsaponifiables.

3. The process according to claim 1 wherein one of the first or second fractions comprises sodium salts of fatty acids and rosin acids.

4. The process according to claim 1, wherein the alcohol used in step a) is methanol.

5. The process according to claim 1, further comprising:
isolating phytosterols from the first fraction.

6. The process according to claim 1, wherein step b) is carried out at a temperature of from 30° C. to 60° C.

7. The process according to claim 4, wherein an amount of methanol in the mixture of step a) is at least 10 wt-% based on a total weight of the mixture of step a).

8. The process according to claim 1, wherein phytosterols in the first fraction spontaneously crystallize.

9. The process according to claim 8, wherein the spontaneously crystallized phytosterols comprise beta-sitosterol.

10. The process according to claim 1, further comprising:
producing a tall oil having an acid number of at least 175 from the second fraction.

11. A fraction separated and recovered according to the method of claim 1.

12. A composition comprising:
tall oil having an acid number of at least 175,
said composition comprising less than 0.5 wt-% phytosterols, based on a total weight of the composition.

13. A composition comprising:
phytosterols, wherein the composition comprises less than 0.5 wt-% tall oil and wherein the composition comprises less than 1 wt-% esterified phytosterols.
